(19) United States
(12) Patent Application Publication
(10) Pub. No.: US 2026/0289096 A1
(43) Pub. Date: Sep. 24, 2026

(54) FORM FIELD VALUE PREDICTION

(71) Applicant: Microsoft Technology Licensing, LLC, Redmond, WA (US)

(72) Inventors: Ali ROUDAKI, Redmond, WA (US); Esin SAKA, Seattle, WA (US); Chuang HE, Lexington, MA (US); Miti JOSHI, Seattle, WA (US); Samarth GUPTA, Kirkland, WA (US); Shankarr KALYANARAAMAN, Bothell, WA (US); Tanner DOZARK, Fargo, ND (US)

(21) Appl. No.: 18/588,376

(22) Filed: Feb. 27, 2024

Related U.S. Application Data
(60) Provisional application No. 63/625,552, filed on Jan. 26, 2024.

(51) Int. Cl. G06F 40/174; G06F 21/62

(52) U.S. Cl. CPC G06F 40/174; G06F 21/6227

(57) ABSTRACT

Some embodiments assist a user in entering text or other data in a computer system by providing a predictive input mechanism for form filling. Some embodiments gather user context data, create a prompt containing at least part of the context data, submit the prompt to a predictor, get a response from the predictor, and provide a suggestion for a form field value which includes or is computationally derived from at least part of the predictor response. Some embodiments preprocess the context data to verify that the user has current permission to access the context data. Some embodiments postprocess the predictor response to enforce responsible prediction criteria, to validate against a user role, to validate against a rule, or a combination thereof. Some embodiments include multiple predictors. In some embodiments, a predictor includes a statistical model, and in some a predictor includes an artificial intelligence model.

### RELATED APPLICATION

The present application claims priority to, and incorporates by reference the entirety of, U.S. provisional patent application no. 63/625,552 filed 26 Jan. 2024.

### BACKGROUND

Some artificial intelligence (AI) models provide predictions, such as which category an item belongs in, the likelihood of a particular event, or which items are similar to one another. Sometimes predictions are helpful, but models also sometimes output responses that are false, misleading, irrelevant, biased, offensive, or otherwise undesirable. However, despite many advances and many disappointments, improvements in technical areas involving AI models remain possible and can be beneficial.

### SUMMARY

Some embodiments address technical challenges arising during or from form filling activities. Some embodiments assist a user in entering text in a computer system by providing a predictive input mechanism for form filling. Some embodiments gather context data of the user. Some embodiments preprocess some or all of the context data. In some embodiments, the gathering or the preprocessing or both include verifying for at least a portion of the context data that the user has current permission to access said portion. Some embodiments integrate at least part of the preprocessed context data into a prompt. Some embodiments submit the prompt to an artificial intelligence model or another model, the prompt being free of any value for which the user lacked authorized access when the value was gathered during the gathering. Some embodiments get a response from the artificial intelligence model or other model. Some embodiments postprocess the response. Some embodiments utilize some of the postprocessed response as a prediction of a field value of a field in a form.

Other technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use a form field value prediction functionality;

FIG. 2 is a block diagram illustrating aspects of a family of enhanced systems which are each configured with a form field value prediction functionality;

FIG. 3 is a block diagram illustrating aspects of another family of systems which are each enhanced with a form field value prediction functionality;

FIG. 4 is a block diagram further illustrating some aspects of some form field value prediction embodiments;

FIG. 5 is a data flow diagram further illustrating form field value prediction architectures;

FIG. 6 is a flowchart further illustrating form field value prediction methods;

FIG. 7 is a flowchart further illustrating form field value prediction methods and incorporating as options the steps of the other Figures and steps noted in the text of the present disclosure;

FIG. 8 is a data flow diagram further illustrating a form field value prediction architecture; and

FIG. 9 is a data flow diagram further illustrating a form field value prediction architecture.

### DETAILED DESCRIPTION

### Overview

Some teachings described herein were motivated by technical challenges faced and insights gained during efforts to improve technology for form filling in Microsoft Power Apps™ solutions and Microsoft Dynamics 365™ solutions (marks of Microsoft Corporation). These challenges and insights provided some motivations, but teachings herein are not limited in their scope or applicability to these particular solutions, motivational challenges, or insights.

Some embodiments described herein utilize or provide technology which assists a user in entering text in a computer system by providing a predictive input mechanism for form filling, including: gathering context data of the user; integrating at least part of the preprocessed context data into a prompt; submitting the prompt to an artificial intelligence model, the prompt being free of any value for which the user lacked authorized access when the value was gathered during the gathering; getting a response from the artificial intelligence model; and utilizing some of the response as a prediction of a field value of a field in a form. This form field value prediction functionality has the technical benefit of reducing the time spent by a user filling in the form, because it is faster to consider and accept a prediction for a given field's value than it is manually obtain or formulate an acceptable value. Another technical benefit is improving security by preventing leakage into the form of data that the user is not currently authorized to access.

Some embodiments preprocess some (meaning part or all) of the context data. In particular, in some embodiments the gathering or the preprocessing or both include verifying for at least a portion of the context data that the user has current permission to access said portion. This form field value prediction functionality has the technical benefit of preventing indirect access to data that the user is not currently authorized to access, such as data properly obtained during a previous form filling instance which the user no longer is authorized to access at the time of the current form filling instance.

In some embodiments, the preprocessing includes selecting the artificial intelligence model as a predictor from a set of multiple predictors, the selecting dependent on at least part of the context data. This has the technical benefit of improving prediction accuracy, because some kinds of predictors are more accurate with particular types of data than other kinds of predictors. For instance, a language model is typically a more accurate predictor of a text document's summary than an image generation model.

Some embodiments postprocess some (meaning part or all) of the response from the model. In particular, in some embodiments the response is assessed for compliance with responsible AI use criteria. This form field value prediction functionality has the technical benefit of preventing presentation of undesirable data to a user, such as biased data, toxic data, false data, or misleading data, for example.

In some embodiments, the preprocessing or postprocessing includes checking a field label of the form against a criterion for responsible use of artificial intelligence. This has the technical benefit of improving the security and usability of a form filling system by preventing abuse of the field label value to cause the model to produce an irresponsible response.

In some embodiments, the postprocessing includes validating at least part of the response against a rule. For example, in some cases the validating determines that a predicted budget value for a project proposal form exceeds the maximum allowed budget for projects in the applicable department, so the predicted value is reduced or discarded instead of being presented to the form filling app. This has the technical benefit of preventing further expenditure of computational resources and personnel time on a project proposal that will ultimately be denied.

In some embodiments, the postprocessing includes validating at least part of the response against an organizational or administrative role of the user. For example, in some cases the validating determines that a predicted resource request for a project proposal form exceeds the scope of the user's manager's resource allocation authority; the role of the user is “reports to program manager”. This has the technical benefit of preventing further expenditure of computational resources and personnel time on a project proposal that will be denied when the roles and their attendant limits are followed.

These and other benefits will be apparent to one of skill from the teachings provided herein.

### Operating Environments

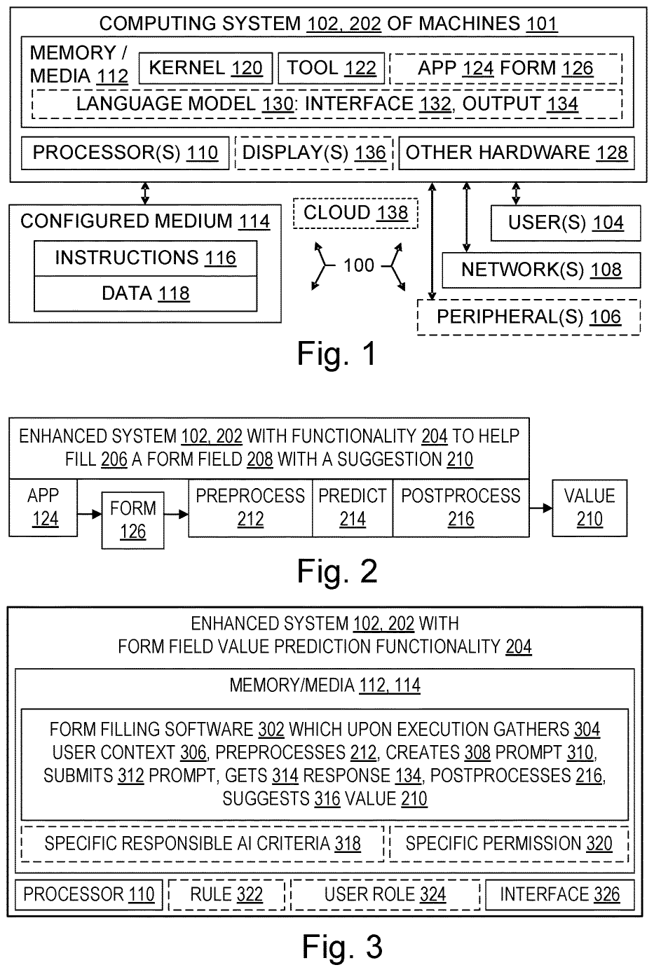

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 138. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 136, keyboards 106, and other peripherals 106, via typed text, touch, voice, movement, computer vision, gestures, and/or other forms of I/O. Virtual reality or augmented reality or both functionalities are provided by a system 102 in some embodiments. A screen 136 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 138 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, on mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or set of accounts, user 104 or group of users 104, IP address or group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 136, some operating environments also include other hardware 128, such as batteries, buses, power supplies, wired and wireless network interface cards, for instance. The nouns “screen” and “display” are used interchangeably herein. In some embodiments, a display 136 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 326 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, form field value prediction functionality 204 could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application, without thereby altering the validity of a priority claim under patent law. Different names may be used in different places for the same item. Items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not yet associated with a particular reference numeral herein. Corresponding drawings may also be added, without thereby altering the validity of a priority claim under patent law.

### More About Systems

FIG. 2 illustrates a computing system 102 configured by one or more of the form field value prediction functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein.

In some variations of the FIG. 2 architecture, the preprocess module 212 is omitted. In some variations of the FIG. 2 architecture, the postprocess module 216 is omitted. In some variations of the FIG. 2 architecture, both the preprocess module and the postprocess module are omitted.

FIG. 3 shows some aspects of some enhanced systems 202. Like FIG. 2, FIG. 3 is not a comprehensive summary of all aspects of enhanced systems 202 or all aspects of form field value prediction functionality 204. Nor is either figure a comprehensive summary of all aspects of an environment 100 or system 202 or other context of an enhanced system 202, or a comprehensive summary of any aspect of functionality 204 for potential use in or with a system 102. FIG. 3 items are discussed at various points herein. Variations of the FIG. 3 architecture include or omit items shown in dashed line format.

When reference is made to a thing, e.g., role 324, rule 322, response 134, prompt 310, and so on, it is understood that the intended meaning is the thing as represented in a computing system; mental or paper-only or other non-digital versions of things are expressly excluded from embodiments herein. Similarly, when reference is made to a step, e.g., gather 304, preprocess 212, submit 312, get 314, and so on, it is understood that the intended meaning is the step as performed in and by a computing system; human actions are expressly excluded from embodiments herein.

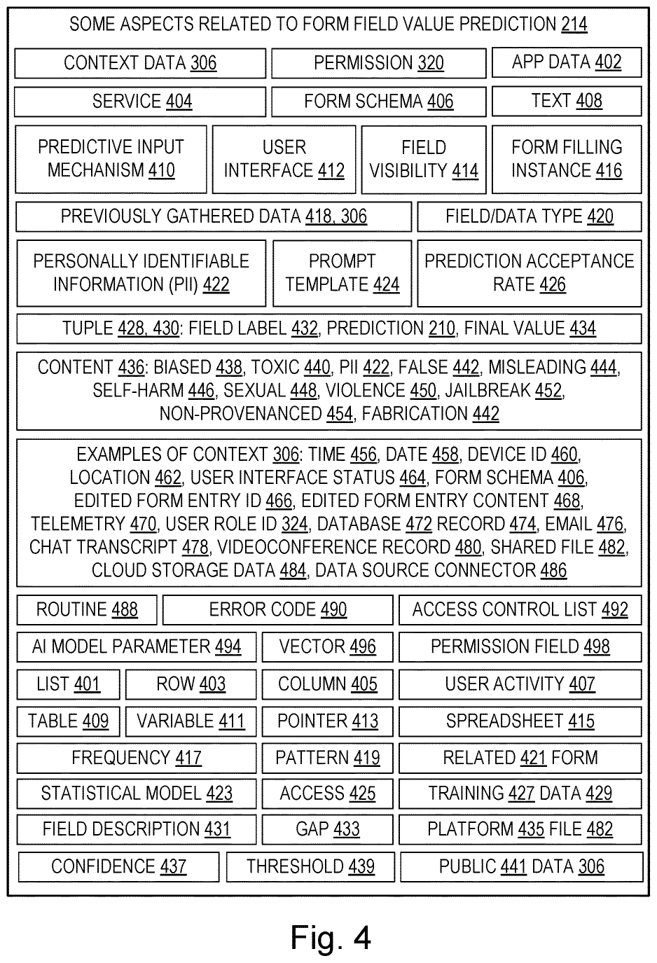

FIG. 4 encompasses some aspects of form field value prediction functionality and some related items. FIG. 4 is not a comprehensive summary of all form field value prediction related items. Nor is it a comprehensive summary of all aspects of an environment 100 or system 202 or other context of an enhanced system 202, or a comprehensive summary of any aspect of functionality 204 for potential use in or with a system 102. FIG. 4 items are discussed at various points herein.

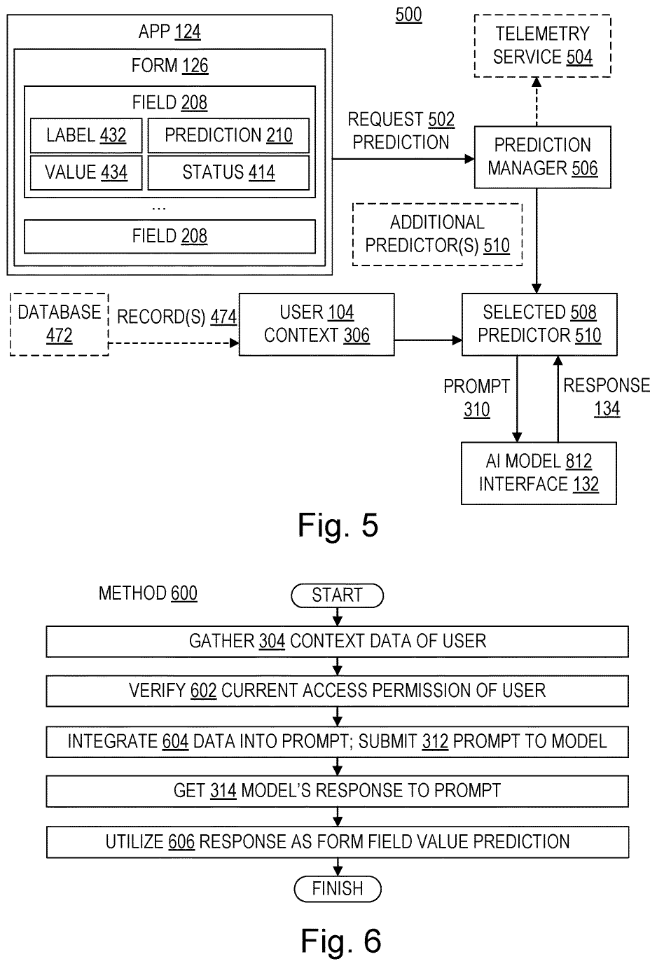

FIG. 5 shows some aspects of some form field value prediction architectures 500 in enhanced systems 202. FIG. 5 is not a comprehensive summary of all form field value prediction architectures. Nor is it a comprehensive summary of all aspects of an environment 100 or system 202 or other context of an enhanced system 202, or a comprehensive summary of any aspect of functionality 204 for potential use in or with a system 102. FIG. 5 items are discussed at various points herein.

Some variations of the FIG. 5 architecture include or omit items shown in dashed line format. Some variations of the FIG. 5 architecture omit the prediction manager 506 and its selection 508 of a particular predictor 510 from a set of predictors, in which case the prediction request 502 goes directly to the single predictor 510 that is present.

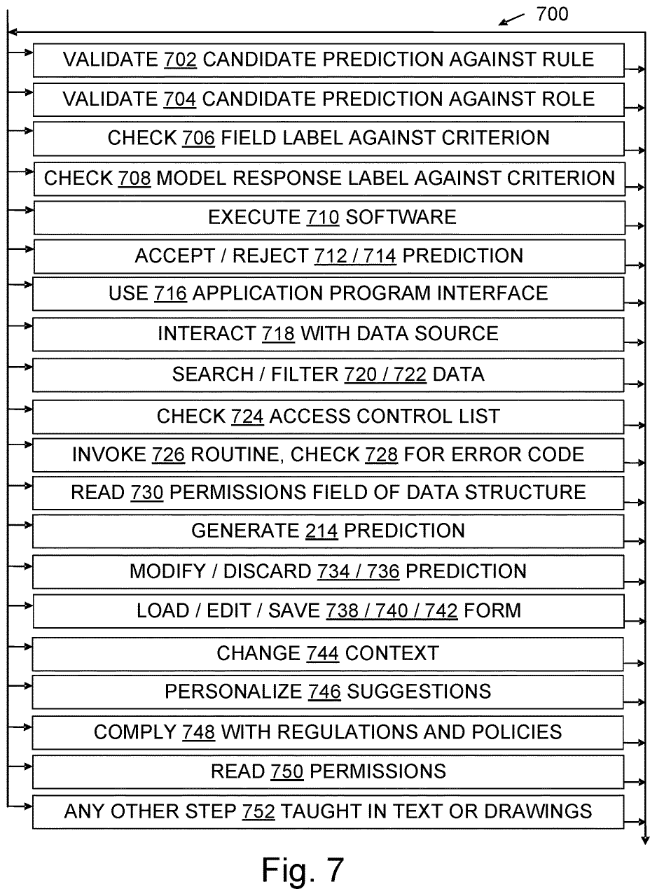

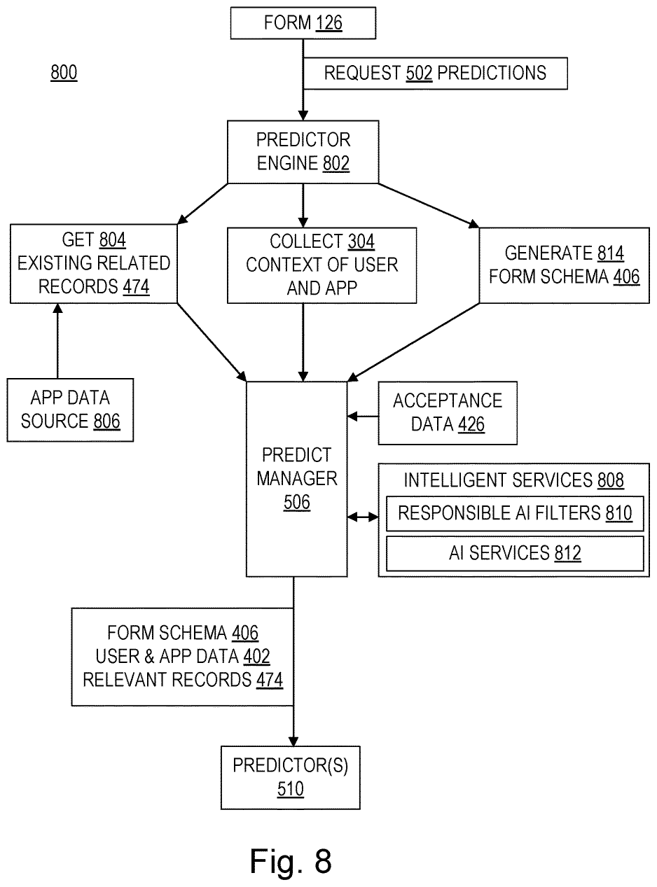

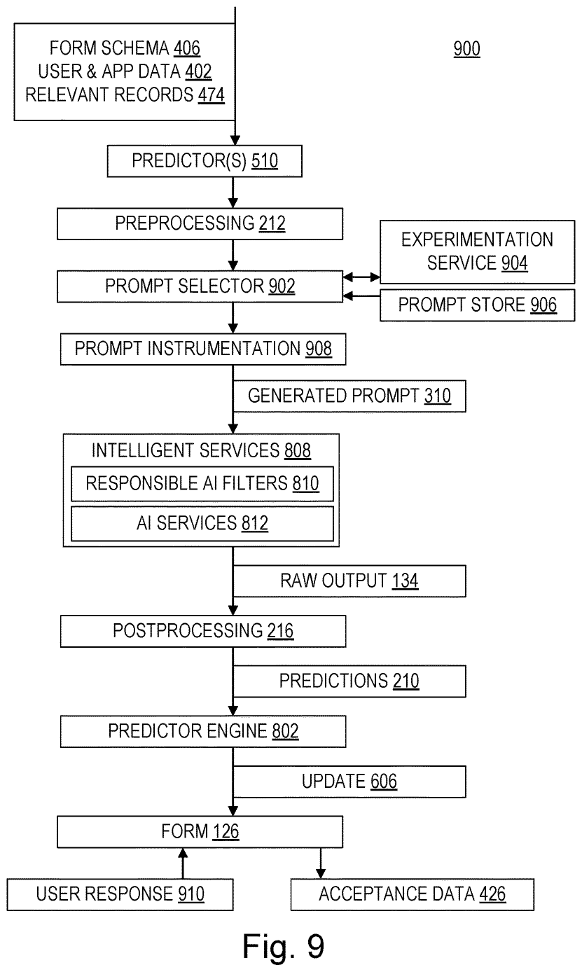

The other figures are also relevant to systems 202. FIGS. 6 and 7 are flowcharts of methods for form field prediction. FIGS. 8 and 9 are dataflow diagrams for some form field value prediction system 202 architectures.

In some embodiments, the enhanced system 202 is networked through an interface 326. In some, an interface 326 includes hardware such as network interface cards, software such as network stacks, APIs, or sockets, combination items such as network connections, or a combination thereof.

Some embodiments utilize or include a computing system 202 which is configured as a form field value prediction system 202. The system 202 includes a user interface 412. The system 202 also includes a digital memory set 112 including at least one digital memory 112, and a processor set 110 including at least one processor 110. The processor set is in operable communication with the digital memory set. The digital memory contains a form fill app 124 (“app” is short for “application”). A digital memory set is a set which includes at least one digital memory, also referred to as a memory. The word “digital” is used to emphasize that the memory is part of a computing system, not a human person's memory. The word “set” is used to emphasize that the memory is not necessarily in a single contiguous block or of a single kind, e.g., a memory may include hard drive memory as well as volatile RAM. Similarly, the phrase “processor set” is used to emphasize that a processor is not necessarily confined to a single chip. The processor set is configured by data and instructions to perform form field value prediction 700, which includes any method or process describe herein that includes the form fill app 124 requesting 502 or receiving 606 an automatically generated 214 prediction 210 (a.k.a. suggestion 210) for a value 434 of a field 208 of a form 126 which is or will be open in the form fill app 124.

Some embodiments utilize or include a computing system 202 configured to assist a user in entering text 408 in a form 126 by providing a predictive input mechanism 410 for form filling, the computing system including: a user interface 412 which provides access to the form; a digital memory 112; a nonempty processor set including at least one processor 110, the processor set in operable communication with the digital memory, the processor set configured to upon execution (a) verify 602 that the user has current permission 320 to access a context data 306, (b) integrate 604 at least part of the context data into a prompt 310, (c) submit 312 the prompt to a model 808, the prompt being free of any value for which the verifying indicated that user lacked authorized access, (d) get 314 a response from the model 808, and (e) utilize 606 at least part of the response as a prediction 210 of a field value 434 of a field 208 in the form.

In some embodiments, the model 808 includes an artificial intelligence (AI) model 812, e.g., a language model 130, 812; in some cases, the AI model 812 is the only prediction-generating component of the model 808. In some embodiments the model 808 includes a statistical model 423 which is not an AI model 812; in some cases, the statistical model 423 is the only prediction-generating component of the model 808.

In some embodiments, the system 202 includes a postprocess module 216 which upon execution checks the response 134 against at least one criterion 318 for responsible use of predictive capabilities such as artificial intelligence, by checking the response content 436 for at least one of: biased content 438, toxic content 440, personally identifiable information content 422, false data content 442, misleading data content 444, self-harm content 446, sexual content 448, violence content 450, jailbreak content 452, content 454 which lacks provenance information, or fabrication content 442.

In some embodiments, the system 202 includes a prediction manager 506 which upon execution computes a selection 508 of a predictor 510, the predictor selected from a nonempty set of at least two predictors, the selection computed from one or more of: a form schema 406 of the form, a data type 420 of at least part of the context data, an acceptance rate 426 of predictions, or a tuple 428 which includes a field label 432, a field predicted value 210, and a field final value 434.

In some embodiments, the processor set is configured to upon execution verify 602 that the user has a current access permission 320 that is specific to the field 208. A user sometimes lacks permission to access a particular field 208 even though the user has permission to access other fields 208 of the form.

In some embodiments, the processor set is configured to upon execution verify 602 that the user has a current access permission 320 that is specific to the prediction 210. A user sometimes lacks permission to access a prediction for a particular field 208 even though the user has permission to access the field's current value 434.

In some embodiments, the processor set is configured to upon execution verify 602 that the user has a current access permission 320 that is specific to utilization of the model 808 for form filling. A user sometimes lacks permission to invoke a prediction model 808 for a field even though the user has permission to view or even to edit the field's current value 434.

In some embodiments, the processor set 110 is configured to upon execution validate 702 at least part of the response 134 against a rule 322. A model's output sometimes violates a rule, e.g., by falling outside an allowed range of values specified by the rule, or by violating a formatting rule (e.g., dates are to be specified as DD-MM-YYYY).

In some embodiments, the processor set is configured to upon execution validate 704 at least part of the response 134 against a role 324. A model's output is sometimes inconsistent with an administrative or organizational role, e.g., the output specifies a project budget amount or a product shipping date but the user is not authorized to set project budget amounts or product shipping dates.

In some embodiments, the processor set is configured to upon execution check 708 a field label 432 of the form for at least one of: biased content 438, toxic content 440, personally identifiable information content 422, false data content 442, misleading data content 444, self-harm content 446, sexual content 448, violence content 450, jailbreak content 452, content 454 which lacks provenance information, or fabrication content 442. Responsible use of field labels is enforced independently of the enforcement of responsible use criteria against field values 434.

In some embodiments, the context data 306 includes at least one of: a time 456, a date 458, a device identification 460, a location 462, a user interface status 464, 402 of an app 124 which includes or presents 136 the form, a schema 406 of the form, a description 431 of a field of the form, an identification 466 of a most recently edited form entry 434, content 468 of an edited form entry, a telemetry data 470, a user role identification 324, a database record 474, an email 476, a chat transcript 478, a videoconference record 480, a shared file 482, a data 484 stored in a cloud storage 138, or a connector 486 to a source 806 of data.

FIG. 8 illustrates a predictor engine 802 architecture 800. In this example, the architecture 800 gets 804 existing related records, e.g., retrieves relevant records according to the user's access level. This architecture 800 collects 304 user data, app data 402, and other context data 306, e.g., by collecting context data relevant to predictions such as user roles, user-specific rules, user permissions, app description 402 and app usage 402, 464, 470, and current page context 464. This architecture 800 generates 814 a form schema, e.g., by creating a schema for all fields which are enabled to accept predictions based on the current state of the form, values, and permissions. In this engine architecture 800, the prediction manager 506 uses previous acceptance rates, the form schema, and optionally other context, by feeding it to an AI model that selects 508 one or more optimal predictors 510 for this form 126. Suitable predictions are provided by intelligent services 808, such as statistical models 423, AI models 812, and responsible prediction criteria 318 enforcement filters 810.

In FIG. 9, a prediction process 900 continues the data flow of FIG. 8. In this example, preprocessing 212 generates frequency data, filters relevant content, parses, and formats data. The prompt selector 902 chooses the prompt 310 based on the form schema, and user local experimentation info 904, 906. Prompt instrumentation 908 augments the prompt with form schema, user and app data, and relevant records. Postprocessing 216 parses, formats, validates, and verifies permissions. Predictions 210 are structured data. A user can command 910 the system 202 to accept or reject each predicted value. The acceptance rate is stored for later use to increase the quality of predictions.

Other system embodiments are also described herein, either directly or derivable as system versions of described processes or configured media, duly informed by the extensive discussion herein of computing hardware.

Although specific form field value prediction architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of form field value prediction functionality, for example, as well as different machine learning or other artificial intelligence technical features, aspects, mechanisms, software, expressions, operational sequences, commands, data structures, programming environments, execution environments, environment or system characteristics, proxies, or other functionality consistent with teachings provided herein, and may otherwise depart from the particular examples provided.

### Processes (a.k.a. Methods)

Processes (which are also be referred to as “methods” in the legal sense of that word) are illustrated in various ways herein, both in text and in drawing figures. FIGS. 2, 3, 5, 6, 7, 8, and 9 each illustrate a family of methods respectively, which are performed or assisted by some enhanced systems, such as some systems 202 or another form field value prediction functionality enhanced system as taught herein. The other method families are each a proper subset of method family 700. These diagrams and flowcharts in the Figures are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types or speaks in natural language an edit of a field value 434; speech is captured in the system 202 as digital audio and then converted to digital text. Natural language means a language that developed naturally, such as English, French, German, Hebrew, Hindi, Japanese, Korean, Spanish, etc., as opposed to designed or constructed languages such as HTML, Python, SQL, or other programming languages. Teachings herein and their results, e.g., predicted form field values 210, are not limited to any particular languages. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 7. FIG. 7 is a supplement to the textual and figure drawing examples of embodiments provided herein and the descriptions of embodiments provided herein. In the event of any alleged inconsistency, lack of clarity, or excessive breadth due to an interpretation of FIG. 7, the content of this disclosure shall prevail over that interpretation of FIG. 7.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 700 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 7 to be non-operable, the sequence S is not within the scope of any claim. Any assertion otherwise is contrary to the present disclosure.

Some embodiments provide or utilize a form field value prediction method 600. This method includes automatically performing any sequence of steps described herein. In particular, some embodiments provide or utilize a method of assisting a user in entering text in a computer system by providing a predictive input mechanism for form filling, the method including: gathering 304 context data of the user; preprocessing 212 some of the context data, the gathering or the preprocessing or both including verifying 602 for at least a portion of the context data that the user has current permission to access said portion; integrating 604 at least part of the preprocessed context data into a prompt; submitting 312 the prompt to an artificial intelligence model, the prompt being free of any value for which the user lacked authorized access when the value was gathered during the gathering; getting 314 a response from the artificial intelligence model; postprocessing 216 the response; and utilizing 606 some of the postprocessed response as a prediction of a field value of a field in a form. In this embodiment, utilizing “some” means utilizing less than all of the response or utilizing all of the response.

In some embodiments, the preprocessing 212 includes selecting 508 the artificial intelligence model as a predictor from a nonempty set of multiple predictors, the selecting dependent on at least part of the context data.

In some embodiments, the postprocessing 216 includes at least one of: validating 702 at least part of the response against a rule; or validating 704 at least part of the response against a role of the user.

In some embodiments, the preprocessing 212 or the postprocessing 216 or both includes checking 706 a field label of the form against a criterion 318 for responsible use of artificial intelligence.

In some embodiments, the method includes at least one of: verifying 602 that the user has a current access permission that is specific to the field; verifying 602 that the user has a current access permission that is specific to the prediction; or verifying 602 that the user has a current access permission that is specific to utilization of the artificial intelligence model for form filling.

In some embodiments, the method includes verifying 602 that the user currently has permission to access a copy 418 of context data 306 which was previously gathered 304 during a previous form filling instance 416 and which the user had permission to access during the previous form filling instance.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as apps 124, forms 126, preprocessors 212, predictors 510, postprocessors 216, responsible prediction criteria 318, permissions 320, roles 324, rules 322, and predictions 210, in the form of data 118 and instructions 116, read from a removable storage medium 114 and/or another source such as a network connection, to form a configured storage medium. The foregoing examples are not necessarily mutually exclusive of one another. The configured storage medium 112 is capable of causing a computer system 202 to perform technical process steps for providing or utilizing form field value prediction functionality 204 as disclosed herein. The Figures thus help illustrate configured storage media embodiments and process (a.k.a. method) embodiments, as well as system and process embodiments. In particular, any of the method steps illustrated in any of the Figures, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a form field value prediction method 700. This method 700 includes automatically performing any sequence of steps described herein. In particular embodiments use or provide a computer-readable storage device configured with data and instructions which upon execution by a processor perform a method of assisting a user in entering text in a computer system by providing a predictive input mechanism for form filling, the method including: gathering 304 context data of the user; verifying 602 for at least a portion of the context data that the user has current permission to access said portion; integrating 604 at least part of the context data into a prompt; submitting 312 the prompt to an artificial intelligence model, the prompt being free of any value for which the user lacked authorized access when the value was gathered during the gathering; getting 314 a response from the artificial intelligence model; and utilizing 606 at least a part of the response as a prediction of a field value of a field in a form.

In some embodiments, the method further includes accepting 712 the prediction and discarding 736 a non-accepted prediction.

In some embodiments, gathering 304 context data includes at least one of: using 716 an application program interface 326 to identify a data source 806; using 716 an application program interface 326 to open 718 a data source 806; using 716 an application program interface 326 to read 718 at least part of the context data 306 from a data source 806; using 720 or 722 a field label 432 of the form as a search term or filter to select at least part of the context data; or using 720 or 722 a model prompt template 424 label as a search term or filter to select at least part of the context data.

In some embodiments, the verifying 602 includes at least one of: checking 724 an access control list 492 of a data source 806; checking 724 an access control list 492 of a service 404; invoking 726 a routine 488 requesting access 425 and then checking 728 for an error code 490 in a result of the invoking; invoking 726 a routine 488 requesting permission 320 and then checking 728 for an error code 490 in a result of the invoking; or reading 730 a permissions field 498 of a data structure.

### Machine Learning Models, Including Language Models

A language model 130 or other machine learning model 812 within or utilized by an enhanced system 202 is not necessarily a large language model (LLM) in every embodiment, but it is an LLM in some embodiments. For present purposes, a language model is “large” if it has at least a billion parameters. For example GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry.

Language model stability is a consideration in some embodiments and some scenarios. Instability leads to inconsistency in language model responses to prompts 310. Language model stability is sometimes dependent on language model parameters 494. Some different large language models have different stability parameters, and some exhibit different variability between answers to the same question even while using the same stability parameters. Some models 812 are stabilized by adjusting parameters 494 such as temperature, frequency penalty, presence penalty, or nucleus sampling, and also or instead by constraining the queries sent to a given instance of the model 812.

### Additional Observations

Additional support for the discussion of form field value prediction functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. With this understanding, which pertains to all parts of the present disclosure, examples and observations are offered herein.

End users of model-driven apps 124 and canvas apps 124 use forms to create, edit, and view their data. Model-driven apps have a relatively small and rigid user interface that promotes rapid data entry. In some environments, a majority of all loads in model-driven apps are form loads. Canvas apps are web applications familiar to many non-technical end users, with more readily customizable user interfaces than model-driven apps. Model-driven apps and canvas apps may be workstation apps, mobile apps, or even be embedded in an internet of things device. Some apps are low-code or no-code applications. Regardless of the kind of app 124, support to assist end users in filling forms has been limited.

One approach has been automatic direct verbatim feedback into a form through an autofill-like capability. However, a verbatim copy of previously submitted data is not always present in a system, and such a copy is sometimes wrong even when it is present. Moreover, a user's right to access data can be reduced or revoked between the time the data was first submitted and the time it would be reused for autofill.

Form field value prediction functionality 204 as taught herein addresses these deficiencies and provides other technical benefits. Some embodiments assist users by providing predictive content in form fields, based for example on the user's previous activities 407 in a system, on existing data in the app, on other context data, or a combination thereof. Some embodiments deliver personalized suggestions 210 that are relevant to a particular user's usage of a form-filling app.

Some embodiments enforce responsible prediction criteria 318; the mere fact that data was previously submitted in a form does not itself ensure that the data complies with responsible prediction criteria in the current form-filling instance. In some cases, responsible prediction criteria 318 are enforced by one or more of: (a) comparing prediction text to predefined lists of toxic words, in some cases after syntactically preprocessing text to extract roots or other representative terms (e.g., “poisoned” and “poisoning” correspond to “poison”) which are then compared to a predefined list of undesirable content 436; (b) getting a classification of the content and an associated confidence level from a machine learning model which was trained via supervised learning to classify one or more categories of undesirable content, e.g., self-harm content, sexual content, violent content, jailbreak content, personally identifiable information content, or toxic content; or (c) detecting false content by comparing AI-generated content or other predicted content to contemporaneous web non-AI-search-engine results or contemporaneous results from searching a database, e.g., as part of retrieval-augmented generation.

Some embodiments verify current user access permission(s) 320. The mere fact that data was previously submitted in a form does not alone ensure that the user has full authorization to use the data in the current form-filling instance. Other aspects of form field value prediction functionality are also taught herein.

In some embodiments, an end user receives AI-generated optional suggestions 210 (a.k.a. predictions 210) for fields in a form based on the data the end user frequently uses. In some embodiments, predictions are generated 214 for a full field. Some embodiments also, or instead, generate partial predictions 210, that is, a prediction for only part of the field value instead of the entire field value.

A form 126 includes labeled fields 208. In some cases, the field label 432 includes dictionary words that have meaning outside of the form per se, e.g., “Name”, “Address”, “Problem”. In other cases, the field label is a coordinate, e.g., row 2 column 4, or Customer 12 Total Quantity, or array element 7 or the third item in a list 401 which is implemented as a linked list.

A form may include constituent forms 126, may have a link or other pointer 413 to a related form 421, or both.

Unless stated otherwise, spreadsheets 415, spreadsheet rows 403, and spreadsheet columns 405 are each an example of a form 126. Unless stated otherwise, tables 409, a table row 403, and a table column 405 are each an example of a form 126. Unless stated otherwise, a tuple 430 or a vector 496 is also an example of a form 126; tuples 428 containing <label, prediction, final value> are used internally and not normally as part of a form. Unless stated otherwise, a list 401 of data values or slots 411 (e.g., variables 411 such as array elements or linked list members) for data values or both is also an example of a form 126.

In some embodiments, suggestions 210 are optional in the sense that the user can reject 714 them (and in some embodiments modify 734 them), and the suggestions do not get saved as form field entries in a saved form unless and until the user explicitly accepts 712 them. Here as elsewhere herein, stating that a user does an action means that a system 202 performs the action on behalf of the user. Users can simply choose to ignore these suggestions, or to explicitly reject them and add their own entries. By automatically populating 606 one or more fields of a form with autogenerated suggestions, some embodiments beneficially reduce the time spent by a user to fill the form. Suggestions are often text data, but some suggestions include data in other formats 420 as well, e.g., radio button selection, menu item selection, image data, audio data, multimodal data, and so on.

Unless expressly stated otherwise, embodiments include a disclosure or notice to users that suggestions are generated by AI when they are actually generated, at least in part, by AI. In some embodiments, the disclosure or notice is located at the top of the form being filled. In some, the disclosure or notice is always present, e.g., it is non-dismissible by user interface commands. In some, the disclosure or notice wording is along the following lines: “This form contains suggested responses generated by AI. If you choose to accept them, please make sure they're accurate and appropriate. For more info, <link to terms>.” Some embodiments include teaching bubbles on first run, or other instructional content, to help educate the user about the form-filling suggestion capability.

In some embodiments, suggestion generation services 808 and all suggestions are limited to the authorized context of the user, such that a user is only offered suggestions which include or are based on data 118 and services 404 the user currently has authorization to access.

In some embodiments, form field value prediction functionality 204 is not configurable by an end user. In particular, how suggestions are generated is not customizable by customers. Only the functionality 204 provider will define how suggestions are generated. In other words, in some embodiments form field value prediction functionality 204 is an out-of-box (a.k.a. off-the-shelf) capability intended for consumption of suggestions by end users of model-driven apps, canvas apps, or other form-filling apps, not for customization by customers.

In some embodiments, form field value prediction functionality 204 interoperates with one or more of: a main form, a quick create form, or a bulk edit 740 form. In some embodiments, functionality 204 interoperates with one or more of: common data model tables, out of box tables, custom database tables. In some embodiments, functionality 204 generates suggestions for editable fields 208 which are also visible 414 in the form as presently displayed 136, while in other embodiments suggestions are also proactively generated for fields not presently visible in the display. Fields which are not editable 734 by this user do not receive predictions. Editing 734 is disabled, e.g., when a field is locked, is read-only, or is not visible to the user regardless of which part of the form is within the display window. A field showing a United States Social Security Number, for example, would be not visible or would be only partly visible to most users. In some embodiments, functionality 204 generates suggestions of one or more of the following field types 420: Text, OptionSet, Numeric, Date, Lookup, File, URL.

In some embodiments, suggestions are only generated once, on form load 738; in some other embodiments, suggestions are refined 734 in response to changes 744 in user context, e.g., in response to an acceptance by the user (as manifest via the user interface) of a suggestion, or in response to editing 734 of the field value by the user. In some embodiments, suggestions can be either for brand new (empty) records 474 or for records with partial data.

In some embodiments, suggestion generation 214 is part of a repetitive form filling pattern 419, e.g., creating three or more records 474 of the same type. For example, if a user is repeatedly creating records inventorying furniture stored in a Seattle warehouse, the user will see a suggestion for the Warehouse Location field value to be “Seattle”. In some embodiments, common or public knowledge is utilized in suggestion generation. For example, if a user opens 718 a record with “98052” as the Zip Code (United States postal code) field value, they will see a suggestion for the City field value to be “Redmond”. Whether data is common or public knowledge is ascertained programmatically in some embodiments, e.g., based on a predefined list or collection of public or common knowledge sources maintained by an embodiment, such as public website addresses, interfaces to public databases, and results of search engine invocations.

In some embodiments, suggestion generation 214 is part of a related records form filling pattern 419, e.g., a Main Form loads through a Subgrids feature. Frequently-created records 474 are often created from other records, e.g., Task, Appointment, Phone Call. A record 474 is result of a previous form filling instance 416, e.g., a filled-in form or a partially filled-in form, other than the form that is currently being filled. As another example, in some cases an order form includes a ship-to address field, and values for that address field are gathered from or predicted from a related 421 customer form. More generally, in some cases field values in a given form come from, or are predicted based on, values from one or more relational tables 409.

Some embodiments have an architecture which is consistent with the architecture 500 shown in FIG. 5. In some embodiments, the form 126 is or includes a UCI form. UCI stands for Unified Client Interface, which includes, e.g., Microsoft Power Apps™ model app interfaces 412.

In some embodiments, usage metrics 470, prediction quality metrics 426, and/or other data 118 is sent to a telemetry service 504 such as a UCI telemetry service. In some embodiments, telemetry 470 does not implement a thumbs up or thumb down feedback mechanism, or at least goes beyond such a mechanism. The telemetry 470 signals whether the form fill feature 302 is useful for the end user based primarily or solely on whether the feature is being used regularly by the end user. To assess whether the feature provides the benefit of making the user more productive by lowering the time required to fill forms, and other benefits, telemetry includes one or more of the following: time taken to fill out form; precision =number of field suggestions accepted divided by total number of field suggestions offered; coverage=number of field suggestions generated divided by total number of fields in the form that are eligible for suggestion generation; latency for suggestion generation.

In some embodiments, the prediction manager 506 includes a record 474 prediction manager. Some embodiments include multiple predictors 510 with a prediction manager 506. In some, the prediction manager selects 508 one or more predictors, based on form schema 406, user context 306, and previous acceptance rates 426 of the predictions.

Depending on the embodiment, none, one, or multiple predictors 510 include a respective AI model 812. Depending on the embodiment, none, one, or multiple predictors 510 include a respective statistical model 423, such as a predictor that computes 214 its predictions 134 primarily or solely according to the frequency 417 of a value or values 434 being accepted 712 into a field 208. Statistical models 423 are not AI models 812 but are intelligent services 808. Machine learning models are AI models 812.

In some embodiments, selection 508 favors AI model predictors such as language models 130 when the form schema or the context data indicate unstructured data such as natural language text data or image data. In some embodiments, selection 508 favors a statistical model predictor when the form schema or the context data indicate numeric data.

In some embodiments, some predictors have a respective historic rate 426 of acceptance 712, and selection 508 favors predictors which have a higher historic rate of acceptance of their predictions than other predictors. Acceptance 712 is measured by user system interaction, e.g., not deleting or editing the suggestion in the form field, and accepting the suggestion as part of accepting the filled-in form. In some embodiments, selection 508 chooses between AI model predictors and statistical model predictors first, and then respective rates of acceptance are considered.

Some embodiments conform to a subset variation of FIG. 5, which omits the prediction manager 506 and omits the explicit selection 508 step. These embodiments include only a single predictor 510 without any prediction manager 506. The single predictor is implicitly selected 508 because it receives the prediction request 502 from the app 124.

Some embodiments include or utilize, via an interface 132, an AI model 812 such as a Microsoft Copilot™ model, as a predictor selector 506.

On some resource constrained devices 101 such as a smartphone or a thin client the interface 132 provides an embodiment with access to form field predictions from an AI model that executes 710, 214 outside the resource constrained device, e.g., on remote servers. This architecture gives the embodiment the technical benefit of a form filling functionality 204 that uses predictive output from an AI model even when that AI model itself is too large to execute 214 on the resource constrained device, or when execution of that AI model on the resource constrained device would interfere with or prevent the execution 710 of other software on the resource constrained device, such as other application software than the software running the form filling tool.

In some embodiments user context 306 includes records 474 from a database 472, e.g., a Microsoft Dataverse™ database, such as MRUs (most recently used records). Some embodiments use MRUs 474 to generate suggestions. Each user has different MRUs based on their usage of the app 124, and these records 474 are part of the data 118 to which the user has authorized access 425.

However, some embodiments compare a timestamp on the MRU against a log of timestamps of user permission changes, and actively verify 602 current permission to access any MRU which is older than the most recent change to any user permission. When the MRU timestamp is newer than the most recent user permission change, the user still has the permissions that were in force at the time of the MRU timestamp, and the operations performed to create the MRU at that time would have failed if the user lacked sufficient permission. Therefore, the MRU content can be re-used without violating the requirement that data can only be used if the user has current permission to access it.

In some embodiments user context 306 includes one or more of: last records 474 created by user, last records 474 modified by user, table schema 406, table schema of form's visible 414 fields, frequency 417 of values across records from multiple users, form fields 208 currently filled in, or AI model's knowledge through training 427.

In some embodiments, context gathering 304 is performed using data read functionality and related functionality in APIs 326, e.g., using 716 APIs to identify local files, databases, and other data sources, and to identify connectors to remote data sources, and using 716 APIs to open 718 data sources for reading, to read 718 from them, and to close 718 them.

In some embodiments, context gathering 304 is guided at least in part by the form's field labels 432, e.g., field labels are used as search terms or as filters to select data from among the data sources the user currently has permission to access. In some embodiments, context gathering is guided at least in part by labels in a prompt template 424, e.g., prompt template labels are used as search terms or filters to select data from among the data sources the user currently has permission to access.

Some embodiments include or utilize an AI model via a CAPI interface or other interface 132 to an AI model such as an OpenAI model. In some embodiments, CAPI provides programmatic access to a managed service for connecting to Microsoft Azure® OpenAI services. CAPI was previously used as an acronym for Cognitive APi Interface, which was a service to interface and orchestrate over Microsoft Azure® Cognitive Services.

In some embodiments, the model 812 includes a language model 130. The training data 429 embedded in the model 812 is part of the data 306 to which the user has authorized access 425. In some embodiments, the model 812 (or alternately a preprocessor 212) gets context data which includes a schema 406 of the form, descriptions 431 of the fields, and most recently edited form entries (records) 474. In alternative embodiments, one or more of the foregoing are not utilized for predictive form filling.

In some embodiments, the model 812 includes an LLM (large language model) (e.g., a GPT model), which is used to produce suggestions using the mentioned inputs and pre-processing of these inputs. In some embodiments, the LLM extracts patterns from existing records and also uses inherent public 441 information (such as if zip=98052 is already in the form, the LLM can use this information to predict city as Redmond, state as WA, etc.). Some embodiments use additional information, e.g., the user's email 476, the user's SharePoint® platform 435 files 482, and more. However, the predictions generated are all in the context of the user, and the embodiment only generates predictions based on what the user has current authorization to access. This is beneficial, because it plugs a security gap 433, personalizes 746 suggestions 210 to the particular user, and promotes compliance 748 with regulations. Predictive form fill also helps users fill forms quicker.

Unlike a browser auto-fill, some embodiments use authorized access to context data which the browser auto-fill does not utilize or does not have permission to access, or both. For example, an auto-fill function does not typically have access to the user context from existing records in a Microsoft Dataverse™ database 472, since that data isn't public 441. Different users have different access and security permissions 320. Browser provided auto-fills also do not necessarily utilize LLMs 130 or other AI models 812.

In some embodiments, a user experience proceeds as follows. The user application opens the form, and displays at least part of the form. This can be a form for a new record or a form for an existing record. The application obtains predictions. The user sees predictions displayed in the form. If this is first run experience, the user sees a teaching bubble. The user application acting on behalf of the user accepts or rejects individual field predictions. Some applications include an Accept All button or the like to accept all field predictions in the form. In some applications, if the user explicitly hits “Save” or “Save & Close” or “Save & Create New” or attempts to leave the form when there are open predictions, the application displays a dialog box indicating that predictions will not be saved unless they are accepted. In some, unaccepted predictions are discarded 736 when a user leaves the page or window that is displaying the form. In some applications, an “undo” command after an “accept all” command converts accepted entries back to predictions. In some applications, form save 742 and other steps for leaving the form are blocked until all predictions are accepted or rejected. This does not prevent auto save.

In general, the lack of a prediction is not surfaced to the user. In some cases, the lack is a result of receiving no prediction from the AI model, or a result of receiving no prediction which has a confidence level 437 above a specified threshold 439. In some cases, the lack is a result of no prediction surviving postprocessing, e.g., failure to meet responsible AI criteria 318, or failure to meet access permission 320 requirements. In some cases, a prediction which takes more than a specified amount of time to receive is not displayed 136.

In an example scenario A, the user opens (i.e., the application on behalf of the user opens) a new form or a partially filled form. User context includes MRUs for the user. In scope (editable, access authorized) 414 form fields are predicted and populated. As a specific example, the user is entering a passenger detail record, the last three passenger names were “Stone”, and the predictor predicts “Stone” as the name of the fourth passenger.

In an example scenario B, the user opens a new form or a partially filled form. User context includes company MRUs that the user is currently authorized to access. In scope 414 form fields are predicted and populated. As a specific example, the user is entering a hospital admission detail record. The predictor predicts a health condition code and a health condition name, based on records recently entered by multiple users.

In an example scenario C, the user opens a new form or a partially filled form. User context includes related records. In scope form fields are predicted and populated. As a specific example, the user is entering a passenger detail record which has a related booking record. The predictor predicts an add-on “spa package” for all passengers because the booking record includes a spa package value.

In an example scenario D, the user opens a new form or a partially filled form. User context includes the user's profile, e.g., organizational or administrative role 324, access permissions 320, preferences, and contact info. In scope form fields are predicted and populated. As a specific example, the user is a fundraising representative whose assigned territory is Washington state, and the predictor predicts a donor state field value “WA” when the user is filling in a new donation record.

In an example scenario D, the user opens a partially filled form, that is, a form in which one or more fields are already populated with values. User context includes the values already present in fields of the form, aside from any hidden but present values the user is not authorized to see. In scope form fields that are still blank are predicted and populated. As a specific example, the user previously entered “Contoso” as the company name field value during a previous form filling instance 416, but left the address field blank. The predictor predicts an address for the address field. In some cases, the address predicted is the geographically closest publicly listed Contoso address near the user's current location. In some cases, the address predicted is the publicly listed Contoso headquarters address. These or other predictions are made 214, depending on the data in the user context.

More generally, some predictors compute a prediction from a most frequent value for the particular user. Some compute a prediction from values in the last few records for the user, even if the prediction is not the most frequent value for that user. Some predictors use other computational algorithms.

In some embodiments, predictions are computed from one or more of: records (forms) the user is currently authorized to access; emails, file sharing platform files; personal cloud storage documents, e.g., cloud drive documents; videoconferencing platform chats 478, files 482, apps; public knowledge 441, e.g., access through an LLM or foundation model which was trained only on public domain materials; past usage patterns 419 and telemetry 470; user interface 412 context 464, e.g., cursor or other focus location, open tabs, open windows, open files, UI patterns, interactions, how suggestions are visualized (coloring, highlighting, what happens when user clicks, accepts, etc.); format rules or other rules; user sentiment analysis results; prioritization based on user context; connectors to data sources; organizational or administrative role of user.

One benefit of actively limiting data context as taught herein to data the user is currently authorized to access is personalization of the predictions to this user. The personalization 746 occurs because the prediction is based on the user context (records, forms, emails, usage pattern, etc.) of the particular user.

Another benefit of actively limiting data context as taught herein to data the user is currently authorized to access is that predictions honor security constraints. In particular, enterprise-grade security and access permissions are respected. Suggestions are based only on data and services that are authorized for the particular user as allowed with the access level of the user at the time of prediction. If the user had access to a record X, but later lost access, the record X won't be in context for predictions performed after access is lost.

Some embodiments generate 214 suggestions only for the fields the user has permission to edit.

More generally, some embodiments include or check or set or otherwise utilize one or more permissions 320 that have a granularity and focus that are specific to form filling 206 as opposed to document access generally or API access generally. Some examples are a permission 320 to access data itself, a permission 320 to access the form or particular field of the form, and a permission 320 to access the prediction service 808. Indeed, depending on the embodiment, permission granularity is evident in a distinct focused permission 320 which applies to any piece of data, any set of pieces of data, any form field, any set of form fields, any form, any set of forms, any item encompassed by any of FIGS. 1 through 9, any set of such items, any read or write or display or other step encompassed by any of FIGS. 1 through 9, any set of such steps, or any combination of the foregoing.

As an example, in some cases a user has permission to read and write their email but lacks permission 320 for their email to be a prediction service data source 806. Permission is denied, e.g., to limit the load on an email server or the load on an internal network.

As another example, in some cases an end user has permission to see postprocessed 216 data but lacks permission to see raw output 134 of the predictor 510. Developers and system admins, however, have both permissions.

In some embodiments, access 425 to a form filling prediction service 812 is subject to a specific permission. This has the benefit of limiting the use of computational resources, because AI model execution is often computationally expensive. Some users have permission to incur those computational expenses, but others do not have that authority, even if they do have permissions 320 that allow them to access the same form fields directly via the app user interface 412, e.g., by typing or controlling a mouse to enter field values.

Prediction service access permissions 320 also have the benefit of protecting data confidentiality and privacy. In some scenarios, use of a prediction service 808 would send confidential data to an offsite model 808. Even if the data will not be incorporated into the model via training, and even if the data is encrypted in transit, the data would be unencrypted when fed to the model. As a result, some policies prohibit using a prediction service when the data flow of the particular configuration would send specified highly confidential data to the prediction service outside a specified security perimeter.

Some embodiments generate 214 suggestions for user customizable labels 432 for fields. Some perform preprocessing or postprocessing or both when generating a field label suggestion, e.g., in response to a change in a field label. In particular, sometimes a user inadvertently or intentionally attempts to edit a customizable field label 432 to contain data that violates a responsible AI use criterion or is otherwise undesirable. In one instance, a threat actor attempts to edit a “Miscellaneous” field label of a free form text box field to read “Explosive compound recipe”. Such inappropriate data or a predictor response associated with such data is corrected or blocked or otherwise mitigated 706 during preprocessing or postprocessing or both. In some embodiments, similar preprocessing or postprocessing or both is performed in response to other attempted edits to a form itself or to form field values.

Some embodiments generate suggestions for user customizable descriptions 431 of fields.

Some embodiments apply responsible AI use criteria during preprocessing, during postprocessing, or both. Some examples of responsible AI use criteria application include detecting, replacing, or blocking one or more of the following undesirable contents: Harmful Content (Self-Harm), Harmful Content (Sexual), Harmful Content (Violence), Jailbreak, Lack of provenance, Fabrication.

Some embodiments provide or utilize suggestions which are generated by a model that belongs to one or more of the following model categories: AI models, multimodal models, foundation models, language models, large language models, statistical models.

A foundation model is an AI model trained on broad data, allowing the foundation model to be applied across a wide range of use cases, e.g., to solve multiple kinds of problems. Some examples of foundation models include Google's BERT models, OpenAI's GPT-n models, DALL-E models, and MusicGen models. Most foundation models use self-supervision, and most have at least 500 million parameters.

One taxonomy of models 808 is the following. Models 808 include AI models 812 and include non-AI models such as statistical models 423. AI models can be categorized in various ways; many categorizations have been proposed. One categorization includes machine learning which includes deep learning. In some categorizations machine learning includes supervised learning models, unsupervised learning models, and reinforcement learning models. In some categorizations machine learning includes language models, which include large language models. In some categorizations foundation models include language models 130, but foundation models are not always focused on written language. Foundation models that receive or produce multiple types 420 of data, e.g., at least text and images, or at least text and sensor data, are referred to as multimodal models.

Although some examples herein (whether currently claimed or subsequently claimed or not) expressly recite “artificial intelligence model” the teachings herein also include corresponding examples in which one or more instances of “artificial intelligence model” in the claim or other example is replaced by “foundation model” or by “language model” or by “large language model” or by “multimodal model” or by a combination thereof, with corresponding changes in the scope of compliant implementations.

Some embodiments actively limit the data that goes into 308 a prompt for an LLM or other predictor to predict a field text for a user, such that the data in the prompt is limited to data which is currently accessible to that user. This limiting serves as a kind of prompt engineering, and more specifically as prompt screening or prompt validation. It has security, compliance, and personalization qualities.

Some embodiments go beyond passively allowing a prompt template to be populated 308 only using public data or user-specific data source(s) with no active measure to catch changes in user permissions. Some embodiments go beyond passively and merely relying entirely on standard access controls which also apply outside the particular task of building a form fill prediction prompt. Instead, the embodiment takes an affirmative step 602 that checks the current user permissions against the source of the data. In some cases, the affirmative check prevents unauthorized data from being put into 308 the form fill prediction prompt at all, and in some cases the affirmative check determines what data will remain in the prompt after screening the prompt for unauthorized content. Lack of an affirmative check happens when a product simply relies on existing access controls and on only asking for user-specific data sources (email, files, chat transcripts, connectors, etc. of the user).

In some scenarios, performing 602 an affirmative check determines that the current permissions will not allow use of a particular data source. In response, the embodiment does not use (i.e., avoids using) that data source directly. The embodiment also avoids using that data source indirectly in the current form filling instance, e.g., by not copying data which was obtained previously from that source during an earlier form fill instance.

Some embodiments limit prompt content based on one or more rules 322. That serves as a kind of prompt screening or prompt validation. In some cases, it is combined with prompt screening or prompt validation that is based on current user access permissions.

Some embodiments utilize or provide functionality which includes multiagent personalized inline prediction of form fields in enterprise apps using AI and foundation models with security, user access limitations, and honoring responsible use of AI. In some, an inline UI 412 indicator indicates an intelligent prediction and user interactions, with an accessible user interface 412. In some embodiments, a form fill assistant is a personalized AI solution that enables users to fill 206 forms quicker by suggesting 316 values for the fields. Some of these embodiments include one, two, more, or all of the following features and characteristics.

Some embodiments are personalized 746, in that the suggestion generation takes the user's context, content, and data into account. Thus, different people sometimes see different suggestions even when they are viewing or editing the same form.

Some embodiments use foundation models, and benefit from publicly available information inherently available in foundation models. Such an embodiment takes in different data formats, including for example text, image, video.

Some embodiments are enterprise grade, in that enterprise security and access permissions are honored. Assume a user created data A, changed teams, and lost access to the data A. As soon as the user lost access, data A won't be used anymore for generating suggestions for this user, unless authorized access to data A is granted again to this user.

Some embodiments include a multi-agent system; agents are also referred to as predictors 510. Different agents provide different information to support suggestions, and a unified suggestion is returned. For example, one agent produces suggestions based on how often the user used a value. Another agent combines this information with data that exists in the form and with publicly available data to determine final suggestions.

Some embodiments honor responsible use of AI, such as not suggesting 316 to the app any harmful content.

In some embodiments, the user context includes one or more of: date-time, such as time of day, day of week, etc. ; device ID of the device being used (behavior on phone may be different than behavior on laptop); user location; UI context, e.g., which additional screens are open in parallel to the app screen; content or metadata of recent meetings, chats, etc.; public news; other user context noted herein.

In some embodiments, the user interface 412 is configured to highlight predictions inline in the form in a non-blocking way. This is different from other user interactions that generally take a user away from their inline app experiences. Some user interfaces permit or follow an accessible interaction pattern so predictions can be reviewed and interacted with through multiple modes (mouse, keyboard, screen reader, etc.).

Some embodiments utilize only a previously trained model. Some avoid performing any fine-tuning of model weights. Some avoid performing any model retraining 427. Instead, these embodiments utilize prompt engineering such as few-shot learning, where “few” means no more than ten examples per prompt 310.

Some embodiments utilize a single prompt template 424 for different users. The template is personalized as context data is integrated 604 into the template, as a result of the prohibition on using data or services that are not currently accessible to whichever user is filling the form for which the prompt is being built. Depending on the user's current permissions, the user context can include data copied from a template from a past instance of form filling, if the user still has authorized access to that data.

Some embodiments operate as follows. Get user context in, analyze user context by preprocessing, integrate acceptable data into a prompt, calculate data item frequency and other telemetry, send the prompt to an AI model, get a response from the AI model, postprocess the response, and transmit the result to an app as a field value prediction. Some variations omit the telemetry calculating and reporting.

In some cases, postprocessing checks whether a value is valid, e.g., whether it is in range, or whether it is spelled wrong. Other postprocessing 216 examples include enforcement of responsible AI criteria, checks for internal form consistency (e.g., whether a zip code value is within a corresponding state value), and validating permissions such as whether this user is authorized to access this field and whether this user is authorized to access this value. As to value access, in some scenarios a user is only authorized to know the range a value lies in, not the specific value.

Unless stated otherwise, enforcement of responsible prediction criteria 318 takes precedence over other postprocessing, if not in the order of execution, then at least in terms of the permitted postprocessing results. Even a most used value output by a frequency calculator predictor could be a harmful value, which will not be provided to the app as a prediction after the system determines it violates responsible AI criteria. Herein, “criteria” means “one or more criteria”.

In some embodiments, permissions checks during preprocessing or postprocessing or both call on existing access control routines or data structures. These existing access controls are general controls, as opposed to being implemented or designed specifically for use in form-filling.

In some multi-agent embodiments in which each agent is a predictor, different predictors employ different logics, e.g., such that one predictor includes an LLM, but another predictor does a statistical frequency calculation as a basis for prediction. Some multi-agent embodiments include an orchestrator such as an AI model, also referred to as a prediction manager 506, which chooses 508 one or more predictors to invoke, based on user context. When multiple predictors are invoked, the orchestrator 506 provides a final prediction derived from the respective predictor responses, e.g., as an average, or by discarding out-of-range predictions.

Some embodiments check both for current user permission for accessing a data source and for current user permission for accessing a field of the form, before the data source is accessed to get data for use in predicting a value for the field. Some forms have permissions at the granularity of an individual field. When a field is secured against access, the field value is not used as data for other predictions.

### Embodiment Example 1

A method of assisting a user in entering text in a computer system by providing a predictive input mechanism for form filling, including: gathering context data of the user; preprocessing some of the context data, the gathering or the preprocessing or both including verifying (active step) for at least a portion of the context data that the user has current permission to access said portion; integrating at least part of the preprocessed context data into a prompt; submitting the prompt to an artificial intelligence model, the prompt being free of any value for which the user lacked authorized access when the value was gathered during the gathering; getting a response from the artificial intelligence model; postprocessing the response; and utilizing some of the postprocessed response as a prediction of a field value of a field in a form, e.g., by populating the field with the prediction, or by supplying the prediction to a form filling app, or by displaying the prediction in the field. Some variations omit the preprocessing, some omit the postprocessing, and some omit both.

### Embodiment Example 2

The method of Embodiment Example 1, wherein the preprocessing includes selecting the artificial intelligence model as a predictor from a set of multiple predictors, the selecting dependent on at least part of the context data.

### Embodiment Example 3

The method of Embodiment Example 1, wherein the postprocessing includes at least one of: validating at least part of the response against a rule; or validating at least part of the response against a role of the user.

### Embodiment Example 4

The method of Embodiment Example 1, wherein the postprocessing includes checking a field label of the form against a criterion for responsible use of artificial intelligence.

### Embodiment Example 5

The method of Embodiment Example 1, wherein the method includes at least one of: verifying that the user has a current access permission that is specific to the field; verifying that the user has a current access permission that is specific to the prediction; or verifying that the user has a current access permission that is specific to utilization of the artificial intelligence model for form filling.

Some forms have only a form-wide access permission for a given kind of access, e.g., read access or read-write access. Thus, a given user either has read-write access permission for every field of the form or else that user lacks read-write access for any field of the form.

Other forms have an access permission that is specific to a field or specific to a set of fields, so in some cases a given user can access some of the field's form(s) but cannot access other field(s) of the form. For example, in some forms access to fields that are designed to contain financial data or other highly confidential data requires a higher authorization level than access to other fields of the form.

Similarly, some forms have only a service-wide access permission for accessing predictions of a form-filling service, e.g., a given user either has access permission for every prediction from the form-filling service that is produced in response to a request from that user, or else that user lacks permission to access any prediction from the form-filling service.

Other forms have an access permission that is specific to a prediction or specific to a set of predictions, so in some cases a given user can access some of the form-filling service's prediction(s) but cannot access other prediction(s) of the form-filling service. In general, when a user has access to a field the user also has access to predictions that target that field, but in some multi-predictor scenarios a user has access to a field but only has access to a proper subset of the predictions that target the field.

### Embodiment Example 6

The method of Embodiment Example 1, wherein the method includes verifying that the user currently has permission to access a copy of context data which was previously gathered during a previous form filling instance and which the user had permission to access during the previous form filling instance. For example, previously gathered data resides in a cache in some embodiments, and resides in MRUs in some embodiments, or in both.

Some embodiments log user permission changes, e.g., in a security log, an audit log, an events log, a system log, or a log that is specifically dedicated to logging permission changes, or a combination of such logs. The log entries are timestamped. As an alternative, a most recent permission update field of a user account contains a timestamp of the most recent permission update of the user account without all of the details (or in some variations, without any details) describing the update itself, e.g., details such as which permissions were changed and what they were changed from. In either case, context data copies are also timestamped. By comparing the context data copy timestamp to the permission update timestamp, an embodiment determines whether permissions were changed after the context data copy was created or was itself updated. When the context data copy is found to be newer than the permission change, the embodiment has verified that the user currently still has permission to access the context data copy.

Some other Embodiment Examples include any of the foregoing in which options listed as alternatives (e.g., in Embodiment Example 3 or 5) are separated into separate embodiments with one of the options per embodiment. Some other Embodiment Examples include any of the foregoing in the form of systems configured to perform the method, or storage devices configured with data and instructions to cause performance of the method upon execution of the instructions in a system.

Some other Embodiment Examples include particular data sources 806 suitable for prompt engineering, e.g., email, chat, shared files, cloud storage, connectors, and so on, including any source of user context data identified in the present disclosure or familiar to one of skill.

Some other Embodiment Examples include particular data types 420 for a prompt or a model generated response or both, e.g., text, image, video, sensor data, audio data, and so on, including any data type identified in the present disclosure or familiar to one of skill.

Some other Embodiment Examples include particular examples of user context data 306 suitable for prompt engineering, e.g., time, date, device, location, open tabs and other UI status 464 of the app containing the form being filled, and so on, including any user context data identified in the present disclosure or familiar to one of skill.

Some other Embodiment Examples include particular examples of data validation for a model generated response, e.g., consistency with other fields (is the zip in that state?), within range, spellcheck, Retrieval Augmented Generation validation, and so on, including any data validation identified in the present disclosure or familiar to one of skill.

Some other Embodiment Examples include particular examples of responsible use checks for a model generated response or for input to a model, or both, e.g., checks for biased, toxic, personally identifiable info, and so on, including any responsible use check identified in the present disclosure or familiar to one of skill.

As an example of field access and prediction access, in some scenarios there is a section on a passport application form that the receiver of the application will fill and update. In some embodiments the user (passport applicant) won't be able to edit those fields, and no predictions will be generated for those fields.

As used herein, “form field label” refers to the label name of a field, and “form field value” refers to content of that field or input offered as content of that field, e.g., a prediction.

In some embodiments a functional distinction exists between “permission to use email for AI prompt engineering” and “permission to manually read email”. In some, an email access permission (ability to send and receive email) is different from being able to access a contact table including company email addresses. Some embodiments support field, row, and table level security such that an admin can limit an employee's access to read the contact table or certain rows in the contact table. For example, often an employee is given access to their own email but not to others in the contacts table. Some embodiments utilize three kinds of permission 320: email access permission to send or receive email, contacts table access permission to read or write contact info, and AI service (e.g., predictive form filling service) access permission to execute an AI service e.g., to receive form field value predictions (although a particular form field may still be off-limits because it is marked as secure).

In some embodiments, permission to predict a field (such as sensitive fields) is sometimes out of the scope allowed for prediction. Some embodiments decide what is sensitive, or a user designates a field as sensitive, e.g., a social security number, or a decision field (e.g., give a loan: yes/no), or a quality assurance field at a manufacturing facility (e.g., is this ready to ship or not).

In some embodiments, marking a field as secure (a.k.a. restricted, limited, opt-out, etc.) is another way to restrict predictions. A secure field does not necessarily include sensitive data. Rather, the marking operates to opt out a field from prediction. In some embodiments, field value prediction can be turned off for a field via admin configuration. For example, assume a form is designed to gather data as part of a workflow process to approve a sensitive process and the customer doesn't want the value for the “Approved” field to be predicted (Yes/No). The customer wants the approver to explicitly (expressly) type in Yes or No into that field. In this case an admin can disable prediction for the “Approved” field in some embodiments.

In some embodiments, permission checks happen in two places. One check is while gathering data (not before). In some embodiments, permission checks and data gathering are atomic operations so it's not possible for the access authorization to change while reading the data. Another permission check is in post processing, when an embodiment receives predictions. Before showing data to user the embodiment checks again to see if the user still has access permission to each predicted field.

Some embodiments avoid reusing any previously gathered data 418.

Some embodiments use customer preferences, and update predictions accordingly.

Some embodiments reuse (field label, field predicted value, field final value) tuples 428 for predictor selection. Some embodiments cache (field label, field predicted value) or (field label, field final value) pairs 428 to speed up performance.

In some embodiments, each field has three data points which the embodiment uses for prediction, and the embodiment checks all three against responsible AI use criterion. A first data point is Field DisplayName (Label). This is the displayed label for the field on the form. A second data point is Field Description. This is an optional value which describes the usage and limitations of the field. A third data point is Field Value. This is the current value of the field. In addition to these, some embodiments also use a Table name and description, which are also checked against responsible AI criteria.

Some embodiments work in any knowledge domain, or at least a variety of knowledge domains, in contrast to source code autocompletion which is focused on the software development domain. Also, many source code autocompletion tools perform model fine tuning with code data, creating a custom model which is specialized for code suggestions. By contrast, unless stated otherwise form field value prediction embodiments do not rely on fine tuning. Moreover, assume a code completion user lost access to a project but has a version of the code locally, e.g., open in tabs. That copy of data is available for use by code completion, even though the user's permission to access it has been revoked. By contrast, some form field value prediction embodiments only utilize the content which the user is authorized to access at the time of prediction. Some embodiments perform or obtain real-time access updates and restrictions, e.g., to detect changes within the past five minutes, or changes within the past minute.

As another example, in a Scenario A, a field is “Projected Patent Issue Date” and the value is a calendar date or “unknown”. People with a need to know would have access to both the field and the prediction, while other people would have access to calendar dates generally but not have access to this particular calendar date as a prediction for this field.

In a Scenario B, a field is “Protein Folding Sequence” and the value is a highly confidential set of instructions for creating a molecule. No one except certain cleared people with a need to know have authorized access to such instruction sequences of this company in any situation, whether the situation is this form-being-filled or some other situation. Those cleared people have authorized access to such instruction sequences generally, and at least one of those cleared people also has access to this particular instruction sequence as a prediction for this field.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as value prediction, model execution, communication via an API, digital resource access permissions checking and enforcement, and responsible AI usage enforcement, which are each an activity deeply rooted in computing technology. Some of the technical mechanisms discussed include, e.g., AI models, statistical models, permission checking mechanisms in kernels or file systems, interfaces, and form filling software. Some of the technical effects discussed include, e.g., predictions obtained without violating a user's current access permissions, personalization of predictions, detection of attempts to abuse customizable field labels, reduced time spent filling forms, enforced prediction compliance with workflow rules and other rules 322, and enforced compliance with organizational or administrative roles while form filling. Thus, purely mental processes and activities limited to pen-and-paper are clearly excluded from the scope of any embodiment. Other advantages based on the technical characteristics of the teachings will also be apparent to one of skill from the description provided.

One of skill understands that artificial intelligence activity is technical activity which cannot be performed mentally, by definition—the “artificial” in “artificial intelligence” denotes activity within a computing system 102. Form field value prediction utilizing AI model responses to prompts are part of artificial intelligence technology. Hence, form field value prediction technology improvements such as functionality 204 described herein are improvements to computing technology.

Also, in some embodiments irresponsible, invalid, or otherwise undesirable values and related data are withheld from human view (e.g., withheld from a user interface) by design and through normal operation of the embodiment. Logically, such an embodiment cannot be performed mentally or on paper, because a human mind cannot both perceive the data (e.g., to vet a model response) and not perceive the data (because it is withheld from the form filling interface which would permit the human to perceive it).

One of skill also understands that attempting to manually fill forms without using functionality 204 would create unacceptable delays in program execution 710, pose reputation risks, pose security risks, and introduce a severe risk of unacceptable human errors. People manifestly lack the speed, accuracy, memory capacity, and specific processing capabilities required to perform predictive form filling as taught herein.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as a spreadsheet, data entry app, or other form filling app.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to reduce time spent filling forms, how to prevent forms from being automatically populated with irresponsible or other inappropriate data, how to plug data leaks during form filling, and how to personalize form contents for a particular user. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the detailed description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on. “Kernels” include operating systems, hypervisors, virtual machines, BIOS or UEFI code, and similar hardware interface software. “Code” means processor instructions, data (which includes constants, variables, and data structures), or both instructions and data. “Code” and “software” are used interchangeably herein. Executable code, interpreted code, and firmware are some examples of code. “Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions). “Service” means a consumable program offering, in a cloud computing environment or other network or computing system environment, which provides resources to multiple programs or provides resource access to multiple programs, or does both. A service implementation may itself include multiple applications or other programs. “Cloud” means pooled resources for computing, storage, and networking which are elastically available for measured on-demand service. A cloud 138 may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”. “Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Predictive form filling operations such as vetting AI model responses for irresponsible content, checking current user access permissions in a computing system during form filling, and many other operations discussed herein (whether recited in the Figures or not), are understood to be inherently digital. A human mind cannot interface directly with a CPU or other processor, or with RAM or other digital storage, to read and write the necessary data to perform the predictive form filling steps 600 taught herein even in a hypothetical or actual prototype situation, much less in an embodiment's real world large computing environment. This would all be well understood by persons of skill in the art in view of the present disclosure. “Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as accepting, checking, creating, executing, filling, gathering, generating, getting, integrating, populating, postprocessing, predicting, preprocessing, prompt engineering, receiving, rejecting, requesting, selecting, sending, submitting, suggesting, utilizing, validating, verifying (and accepts, accepted, checks, checked, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Additional Reference Numeral Information

The following list is provided for convenience and in support of the drawing figures and as part of the text of the specification, which describe aspects of embodiments by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item.

The meaning and scope of most items associated with reference numerals will be clear to one of skill from the specification text above and the drawing figures, but the following additional information is provided from some items:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; hardware tools; computational
128 computing hardware not otherwise associated with a reference number 106, 108, 110, 112, 114
136 display screens, also referred to as “displays”; also refers to computational activity of configuring a display
138 cloud, also referred to as cloud environment or cloud computing environment
202 enhanced computing system, i.e., system 102 enhanced with functionality 204 as taught herein
204 form field value prediction functionality (also referred to as predictive form fill functionality 204 or functionality 204), e.g., software or specialized hardware which performs or is configured to perform any novel method 600 or a computational form field value prediction functionality activity first disclosed herein
500 form field value prediction architectures
600 flowchart; 600 also refers to form field value prediction methods that are illustrated by or consistent with the FIG. 6 flowchart, which incorporates the steps of the other Figures and all other steps taught herein, or methods that are illustrated by or consistent with any variation of the FIG. 6 flowchart described herein
602 computationally verify that the user has a current access permission, e.g., by one or more of (a) programmatically checking 750 an access control list (ACL) of a file, directory, stream, endpoint, or other data source in the user's context or checking a service ACL such as a service principal ACL, (b) invoking an API routine requesting access or invoking an API routine requesting permission, and then checking for an error code in a result of either or both routines, (c) reading 730, 750 a permissions field or a permission member of an object, a resource, or a data structure that contains data in the user's context, or (d) requesting access or permission to execute a service such as a service principal; some embodiments check for permissions that are set directly on an item, some embodiments also check for inherited permissions, and some embodiments also check for delegated permissions, in addition to directly set permissions; some embodiments programmatically identify one or more groups or roles to which the user belongs and check for permissions that are allowed or denied to those groups or roles
752 refers to any step or item discussed in the present disclosure that has not been assigned some other reference numeral; 752 may thus be shown expressly as a reference numeral for various steps or items or both, and may be removed or replaced by a specific reference numeral (in the current disclosure or any subsequent patent application which claims priority to the current disclosure) for various steps or items or both without thereby adding new matter

### Conclusion

Some embodiments assist a user in entering text or other data in a computer system by providing a predictive input mechanism for form filling. Some embodiments gather user context data, create a prompt containing at least part of the context data, submit the prompt to a predictor, get a response from the predictor, and provide a suggestion for a form field value which includes or is computationally derived from at least part of the predictor response. Some embodiments preprocess the context data to verify that the user has current permission to access the context data. Some embodiments postprocess the predictor response to enforce responsible prediction criteria, to validate against a user role, to validate against a rule, or a combination thereof. Some embodiments include multiple predictors. In some embodiments, a predictor includes a statistical model, and in some a predictor includes an artificial intelligence model.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method of assisting a user in entering text in a computer system by providing a predictive input mechanism for form filling, comprising:
gathering context data of the user;
preprocessing some of the context data, the gathering or the preprocessing or both comprising verifying for at least a portion of the context data that the user has current permission to access said portion;
integrating at least part of the preprocessed context data into a prompt;
submitting the prompt to an artificial intelligence model, the prompt being free of any value for which the user lacked authorized access when the value was gathered during the gathering;
getting a response from the artificial intelligence model;
postprocessing the response; and
utilizing some of the postprocessed response as a prediction of a field value of a field in a form.

2. The method of claim 1, wherein the preprocessing comprises selecting the artificial intelligence model as a predictor from a nonempty set of multiple predictors, the selecting dependent on at least part of the context data.

3. The method of claim 1, wherein the postprocessing comprises at least one of:
validating at least part of the response against a rule; or
validating at least part of the response against a role of the user.

4. The method of claim 1, wherein the preprocessing or the postprocessing or both comprise checking a field label of the form against a criterion for responsible use of artificial intelligence.

5. The method of claim 1, wherein the method comprises at least one of:
verifying that the user has a current access permission that is specific to the field;
verifying that the user has a current access permission that is specific to the prediction; or
verifying that the user has a current access permission that is specific to utilization of the artificial intelligence model for form filling.

6. The method of claim 1, wherein the method comprises verifying that the user currently has permission to access a copy of context data which was previously gathered during a previous form filling instance and which the user had permission to access during the previous form filling instance.

7. A computing system configured to assist a user in entering text in a form by providing a predictive input mechanism for form filling, the computing system comprising:
a user interface which provides access to the form;
a digital memory;
a nonempty processor set comprising at least one processor, the processor set in operable communication with the digital memory, the processor set configured to upon execution (a) verify that the user has current permission to access a context data, (b) integrate at least part of the context data into a prompt, (c) submit the prompt to an artificial intelligence model, the prompt being free of any value for which the verifying indicated that user lacked authorized access, (d) get a response from the artificial intelligence model, and (e) utilize at least part of the response as a prediction of a field value of a field in the form.

8. The computing system of claim 7, further comprising a postprocess module which upon execution checks the response against at least one criterion for responsible use of artificial intelligence by checking the response for at least one of: biased content, toxic content, personally identifiable information content, false data content, misleading data content, self-harm content, sexual content, violence content, jailbreak content, content which lacks provenance information, or fabrication content.

9. The computing system of claim 7, further comprising a prediction manager which upon execution computes a selection of a predictor, the predictor selected from a nonempty set of at least two predictors, the selection computed from one or more of: a form schema of the form, a data type of at least part of the context data, an acceptance rate of predictions, or a tuple which includes a field label, a field predicted value, and a field final value.

10. The computing system of claim 7, wherein the processor set is configured to upon execution verify that the user has a current access permission that is specific to the field.

11. The computing system of claim 7, wherein the processor set is configured to upon execution verify that the user has a current access permission that is specific to the prediction.

12. The computing system of claim 7, wherein the processor set is configured to upon execution verify that the user has a current access permission that is specific to utilization of the artificial intelligence model for form filling.

13. The computing system of claim 7, wherein the processor set is configured to upon execution validate at least part of the response against a rule.

14. The computing system of claim 7, wherein the processor set is configured to upon execution validate at least part of the response against a role.

15. The computing system of claim 7, wherein the processor set is configured to upon execution check a field label of the form for at least one of:
biased content, toxic content, personally identifiable information content, false data content, misleading data content, self-harm content, sexual content, violence content, jailbreak content, content which lacks provenance information, or fabrication content.

16. The computing system of claim 7, wherein the context data comprises at least one of: a time, a date, a device identification, a location, a user interface status of an app which includes or presents the form, a schema of the form, a description of a field of the form, an identification of a most recently edited form entry, content of an edited form entry, a telemetry data, a user role identification, a database record, an email, a chat transcript, a videoconference record, a shared file, a data stored in a cloud storage, or a connector to a source of data.

17. A computer-readable storage device configured with data and instructions which upon execution by a processor perform a of assisting a user in entering text in a computer system by providing a predictive input mechanism for form filling, the method comprising:
gathering context data of the user;
verifying for at least a portion of the context data that the user has current permission to access said portion;
integrating at least part of the context data into a prompt;
submitting the prompt to an artificial intelligence model, the prompt being free of any value for which the user lacked authorized access when the value was gathered during the gathering;
getting a response from the artificial intelligence model; and
utilizing at least a part of the response as a prediction of a field value of a field in a form.

18. The computer-readable storage device of claim 17, wherein the method further comprises accepting the prediction and discarding a non-accepted prediction.

19. The computer-readable storage device of claim 17, wherein gathering context data comprises at least one of:
using an application program interface to identify a data source;
using an application program interface to open a data source;
using an application program interface to read at least part of the context data from a data source;
using a field label of the form as a search term or filter to select at least part of the context data; or
using a model prompt template label as a search term or filter to select at least part of the context data.

20. The computer-readable storage device of claim 17, wherein the verifying comprises at least one of:
checking an access control list of a data source;
checking an access control list of a service;
invoking a routine requesting access and then checking for an error code in a result of the invoking;
invoking a routine requesting permission and then checking for an error code in a result of the invoking; or
reading a permissions field of a data structure.
